(19) United States
(12) Patent Application Publication
(10) Pub. No.: US 2011/0020562 A1
(43) Pub. Date: Jan. 27, 2011

(54) PRINTING DEVICE AND PRINTING METHOD

(75) Inventor: Kazutoshi FUJISAWA, Okaya-shi (JP)

Correspondence Address: WORKMAN NYDEGGER;1000 Eagle Gate Tower, 60 East South Temple, Salt Lake City, UT, 84111, US

(73) Assignee: SEIKO EPSON CORPORATION, Tokyo (JP)

(21) Appl. No.: 12/841,405

(22) Filed: Jul. 22, 2010

(30) Foreign Application Priority Data
Jul. 27, 2009 (JP) 2009-174673

(51) Int. Cl. B05D 3/06; B05C 11/00

(52) U.S. Cl. 427/487; 118/642

(57) ABSTRACT

A printing device includes a storage unit that stores a medium and an attracting unit that attracts the medium. Heads eject radiation curable ink onto the medium. A moving mechanism moves the medium relative to the heads in a moving direction. Preliminary curing units are located on respective downstream sides of the heads in the moving direction and irradiate the radiation curable ink on the medium with electromagnetic waves to preliminarily cure the radiation curable ink. A main curing unit is located on a downstream side of the preliminary curing unit located on the most downstream side so that a distance between the main curing unit and the preliminary curing unit located on the most downstream side is smaller than the length of the medium in the moving direction. The main curing unit irradiates the radiation curable ink on the medium to cure the radiation curable ink.

The entire disclosure of Japanese Patent Application No. 2009-174673, filed Jul. 27, 2009 is expressly incorporated by reference herein.

### BACKGROUND

1. Technical Field

The present invention relates to a printing device and a printing method.

2. Related Art

A conventional technique is known, which includes a storage unit that stores a medium having a predetermined size; heads that eject radiation curable ink to the medium; a moving mechanism that moves the medium relative to the heads in a moving direction; preliminary curing units that are respectively located on downstream sides of the heads in the moving direction and irradiate the radiation curable ink deposited on the medium with electromagnetic waves to preliminarily cure the radiation curable ink; and a main curing unit that is located on a downstream side of the preliminary curing unit located on the most downstream side among the preliminary curing units in the moving direction and irradiates the radiation curable ink deposited on the medium with an electromagnetic wave (for example, JP-A-2004-1437).

In the conventional technique, however, when a distance between the main curing unit and the preliminary curing unit located on the most downstream side is smaller than the length (measured in the moving direction) of the medium in order to reduce the size of a printing device, the main curing process starts before completion of the preliminary curing process. When the main curing unit irradiates the medium with the electromagnetic wave, the medium is deformed by the energy of the electromagnetic wave, and the radiation curable ink (deposited on the medium) moves. Thus, the quality of an image is reduced. It is not possible to prevent the quality of the image from being reduced as well as achieve a reduction in the size of the printing device.

### SUMMARY

An advantage of some aspects of the invention is that it provides a compact printing device that prevents a reduction in the quality of an image.

According to an aspect of the invention, a printing device includes: a storage unit that stores a medium having a predetermined size; an attracting unit that attracts the medium; heads that eject radiation curable ink onto the medium; a moving mechanism that moves the medium relative to the heads in a moving direction; preliminary curing units that are respectively located on downstream sides of the heads in the moving direction and irradiate the radiation curable ink deposited on the medium with electromagnetic waves to preliminarily cure the radiation curable ink; and a main curing unit that is located on a downstream side of the preliminary curing unit located on the most downstream side among the preliminary curing units in the moving direction so that a distance between the main curing unit and the preliminary curing unit located on the most downstream side in the moving direction is smaller than the length of the medium in the moving direction and that irradiates the radiation curable ink deposited on the medium with an electromagnetic wave to cure the radiation curable ink.

Other characteristics of the invention are clarified by the specification and the accompanying drawings.

### BRIEF DESCRIPTION OF THE DRAWINGS

The invention will be described with reference to the accompanying drawings, wherein like numbers reference like elements.

FIG. 1 is a block diagram showing the entire configuration of a printer according to an embodiment of the invention.

FIG. 2 is an outline side view of the printer.

### DESCRIPTION OF EXEMPLARY EMBODIMENTS

At least the following is clarified by the specification and the accompanying drawings.

A printing device includes: a storage unit that stores a medium having a predetermined size; an attracting unit that attracts the medium; heads that eject radiation curable ink onto the medium; a moving mechanism that moves the medium relative to the heads in a moving direction; preliminary curing units that are respectively located on downstream sides of the heads in the moving direction and irradiate the radiation curable ink deposited on the medium with electromagnetic waves to preliminarily cure the radiation curable ink; and a main curing unit that is located on a downstream side of the preliminary curing unit located on the most downstream side among the preliminary curing units in the moving direction so that a distance between the main curing unit and the preliminary curing unit located on the most downstream side in the moving direction is smaller than the length of the medium in the moving direction and that irradiates the radiation curable ink with an electromagnetic wave to cure the radiation curable ink.

This configuration allows the printing device to be small and prevents a reduction in the quality of an image.

In the printing device, the main curing unit is located so that a distance between the main curing unit and the head located on the most downstream side among the heads in the moving direction is larger than the length of the medium in the moving direction. This configuration prevents the reduction in the quality of the image.

In the printing device, the main curing unit uses an electromagnetic lamp to irradiate the radiation curable ink with the electromagnetic wave, and each preliminary curing unit uses a light emitting diode to irradiate the radiation curable ink with the electromagnetic wave.

In addition, a printing method includes: supplying a medium having a predetermined size from a storage unit that stores the medium; causing an attracting unit to attract the medium; causing a moving mechanism to move the medium relative to heads in a moving direction while the medium is attracted by the attracting unit; causing the heads to eject radiation curable ink onto the medium that is attracted by the attracting unit; causing preliminary curing units to irradiate the radiation curable ink with electromagnetic waves to preliminarily cure the radiation curable ink deposited on the medium, the preliminary curing units being respectively located on downstream sides of the heads in the moving direction; and causing a main curing unit to irradiate the radiation curable ink deposited on the medium with an electromagnetic wave and cure the radiation curable ink, the main curing unit being located on a downstream side of the preliminary curing unit located on the most downstream side among the preliminary curing units in the moving direction so that a distance between the main curing unit and the preliminary curing unit located on the most downstream side in the moving direction is smaller than the length of the medium in the moving direction.

This printing method prevents a reduction in the quality of an image and allows the image to be printed in a small space.

### First Embodiment

### Configuration of Printer 1

The first embodiment of the invention describes a case in which a printer 1 is used as the printing device according to the invention.

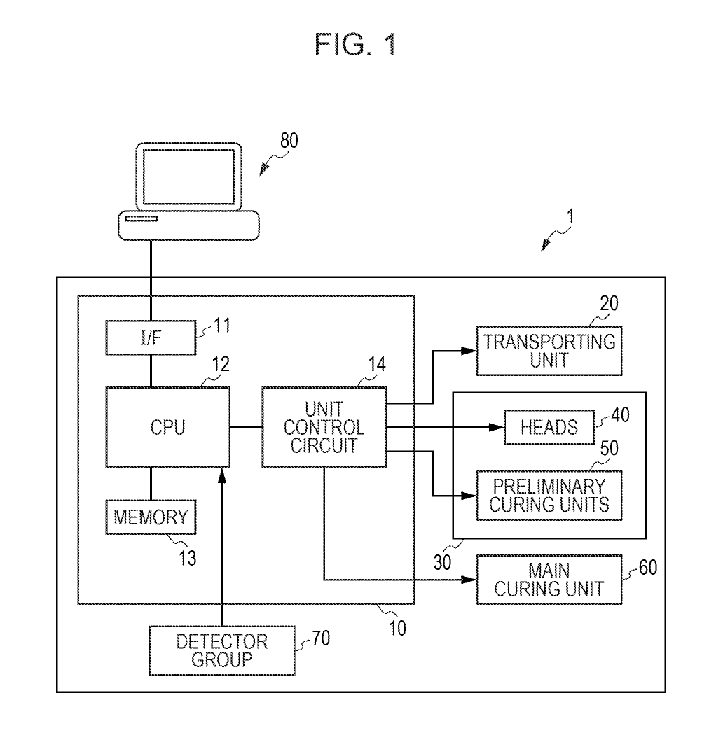

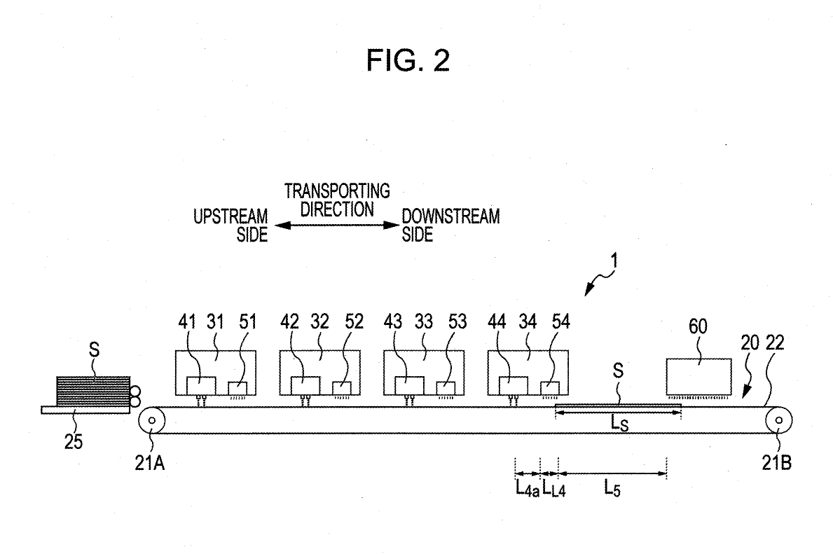

FIG. 1 is a block diagram showing the entire configuration of the printer 1 according to the first embodiment. FIG. 2 is an outline side view of the printer 1. The printer 1 receives a print command (print data) from a computer (external device) 80 and causes a controller 10 to control units (a transporting unit 20, heads 40, preliminary curing units 50 and a main curing unit 60) so that an image is formed on a sheet S. A detector group 70 monitors the performance of the printer 1. The controller 10 controls the units on the basis of the detection results.

The controller 10 is a control unit that controls the printer 1. The printer 1 transmits and receives data to and from the computer (external device) 80 through an interface unit 11. A CPU 12 is an arithmetic processing unit that controls the entire printer 1. A memory 13 includes a working region and a region in which a program that is to be executed by the CPU 12 is stored. The CPU 12 causes a unit control circuit 14 to control the units on the basis of the program that is stored in the memory 13.

As shown in FIG. 2, the printer 1 includes the transporting unit 20, a storage unit 25, four units 30 (a first unit 31, a second unit 32, a third unit 33 and a fourth unit 34) and the main curing unit 60.

The storage unit 25 stores sheets S of A4 and B4 sizes (that correspond to a predetermined size) and supplies the sheets S to the transporting unit 20 one by one.

The transporting unit 20 (that corresponds to a moving mechanism) includes transporting rollers 21A, 21B and a transporting belt 22. The transporting unit 20 moves each sheet S (supplied from the storage unit 25) to positions (at which printing can be performed) and transports the sheet S at a predetermined speed in a transporting direction (that corresponds to a moving direction) during the printing. The annular transporting belt 22 is rotated by the transporting rollers 21A and 21B to transport the sheet S that is placed on the transporting belt 22. The transporting belt 22 moves at a constant speed. Thus, the sheet S is moved at the constant speed from an upstream side to a downstream side by the transporting belt 22. In addition, the transporting unit 20 causes the transporting belt 22 to attract the sheet S electrostatically or by vacuum onto the transporting belt 22 while transporting the sheet S. The transporting belt 22 has an attraction function and corresponds to an attracting unit.

Each of the units 30 includes a single head 40 and a single preliminary curing unit 50. Specifically, the first unit 31 has a first head 41 and a first preliminary curing unit 51; the second unit 32 has a second head 42 and a second preliminary curing unit 52; the third unit 33 has a third head 43 and a third preliminary curing unit 53; and the fourth unit 34 has a fourth head 44 and a fourth preliminary curing unit 54 (that corresponds to a preliminary curing unit that is located on the most downstream side).

Each head 40 ejects ink onto the sheet S. Each head 40 has a plurality of nozzles (ink ejecting units) on a bottom surface of the head 40. Each nozzle has a pressure chamber (that stores ink therein and is not shown in the drawings) and a driving element (that is a piezoelectric element or the like and changes the capacity of the pressure chamber to cause the ink to be ejected from the pressure chamber). When a driving signal is applied to the driving element, the driving element is deformed. The pressure chamber is expanded and contracted by the deformation of the driving element so that the ink is ejected from the pressure chamber.

In the present embodiment, ultraviolet curable ink is used as the ink and cured by the irradiation with ultraviolet light (electromagnetic waves). The ultraviolet curable ink is formed by adding an auxiliary agent (such as an antifoam agent or a polymerization inhibitor) to a mixture of a vehicle, a photopolymerization initiator and a pigment. The vehicle is formed by adjusting the viscosity of photopolymerization-curable oligomer, photopolymerization-curable monomer or the like by means of a reactive diluent. The ink includes both water-based ink and oil-based ink.

The first head 41 ejects white ultraviolet curable ink. As shown in FIG. 2, the first head 41 has two nozzle arrays that eject the white ink and are arranged on the bottom surface of the first head 41. A plurality of nozzles is arranged in each nozzle array of the first head 41 at a predetermined interval (e.g., 720 dpi) in a direction that intersects the transporting direction.

Similarly, the second head 42 ejects cyan ultraviolet curable ink, the third head 43 ejects yellow ultraviolet curable ink, and the fourth head 44 ejects magenta ultraviolet curable ink. Each of the second to fourth heads 42 to 44 has two nozzle arrays, and a plurality of nozzles is arranged in each nozzle array of the second to fourth heads 42 to 44 at predetermined intervals (e.g., 720 dpi) in a direction that intersects the transporting direction. Each head 40 has two nozzle arrays.

Each of the preliminary curing units 50 has a lamp (e.g., an LED or the like) that irradiates the ink (ejected onto the sheet S) with the ultraviolet light to cure the ink. Each lamp is arranged so that a longitudinal direction of the lamp intersects the transporting direction. The length of each lamp in the longitudinal direction is larger than the length of each head 40 so that the ink that has been ejected from the head 40 and deposited on the sheet S can be irradiated with the ultraviolet light. Each lamp has a length in the transporting direction so that a preliminary curing process can be sufficiently performed. Each lamp has a wide surface that faces the sheet S. When an edge of the sheet S reaches a position that corresponds to an upstream-side edge of the lamp of each preliminary curing unit 50, the ultraviolet light irradiation is started. When the other edge of the sheet S reaches a position that corresponds to a downstream-side edge of the lamp of each preliminary curing unit 50, the ultraviolet light irradiation is terminated.

The first preliminary curing unit 51 is located on a downstream side of the first head 41 in the transporting direction and cures the ink that has been ejected from the first head 41 onto the sheet S. The second preliminary curing unit 52 is located on a downstream side of the second head 42 in the transporting direction and cures the ink that has been ejected from the second head 42 onto the sheet S. The third preliminary curing unit 53 is located on a downstream side of the third head 43 in the transporting direction and cures the ink that has been ejected from the third head 43 onto the sheet S. The fourth preliminary curing unit 54 is located on a downstream side of the fourth head 44 in the transporting direction and cures the ink that has been ejected from the fourth head 44 onto the sheet S. Each preliminary curing unit 50 adjusts the energy of the ultraviolet light (with which the ink is to be irradiated) and a time required for the ultraviolet light irradiation to cure the surface of the ink without curing the inside of the ink (this curing corresponds to preliminary curing).

The ultraviolet light irradiation is performed by each preliminary curing unit 50 in order to preliminarily cure the ink. Thus, the amount of the ultraviolet light with which the ink is irradiated by each preliminary curing unit 50 is smaller than the amount of ultraviolet light with which the ink is irradiated by the main curing unit 60 (described later). Therefore, even when each preliminary curing unit 50 irradiates the sheet S with the ultraviolet light, the sheet S is not deformed (for example, the sheet S is not bent).

When the ink is deposited on the sheet S, the ink spreads in every direction on the sheet S from the point at which the ink is deposited. The area of the ink, which is measured when the ink is viewed from the top of the ink, increases over time due to the spreading of the ink. However, when the ink is preliminarily cured, the speed of the spreading of the ink decreases. The spreading of the ink is not stopped by the first preliminary curing. However, the spreading of the ink is almost stopped by the second preliminary curing.

The main curing unit 60 has a lamp (e.g., metal halide lamp or the like) that irradiates each ink (ejected onto the sheet S) with the ultraviolet light to cure the ink. The length (measured in a direction that intersects the transporting direction) of the lamp of the main curing unit 60 is larger than the length of each head 40 so that the ink that has been ejected from the head 40 and deposited on the sheet S can be irradiated with the ultraviolet light by the main curing unit 60 in a similar manner to the lamp of each preliminary curing unit 50. The lamp of the main curing unit 60 has a length in the transporting direction so that a main curing process can be sufficiently performed. The lamp of the main curing unit 60 has a wide surface that faces the sheet S.

The main curing unit 60 irradiates the ink (cured by the preliminary curing units 50 on the sheet S) with the ultraviolet light to cure the inside of the ink (this curing corresponds to main curing).

The main curing unit 60 is arranged on a downstream side of the fourth preliminary curing unit 54. A distance L₅ between a downstream-side edge of the lamp of the fourth preliminary curing unit 54 and an upstream-side edge of the lamp of the main curing unit 60 is smaller than the length L_{S} (measured in the transporting direction) of the smaller one (i.e., A4-sized sheet) of the A4-sized and B4-sized sheets S that are stored in the storage unit 25.

The distance (L₄ₐ+L_{L4}+L₅) between the nozzles of the fourth head 44 and the upstream-side edge of the lamp of the main curing unit 60 is larger than the length L_{S} (measured in the transporting direction) of the larger one (i.e., B4-sized sheet) of the A4-sized and B4-sized sheets S that are stored in the storage unit 25.

### Operations of Printer 1

The following describes a printing process that is performed by the printer 1.

When the controller 10 receives the print data, the controller 10 causes the storage unit 25 to feed the sheet S (stored in the storage unit 25) onto the transporting belt 22. The sheet S is transported by the transporting belt 22 at a constant speed without stopping while being attracted electrostatically or by vacuum using the transporting belt 22. Then, the sheet S is positioned so that the first head 41 faces the sheet S. When the first head 41 faces the sheet S, the controller 10 controls the first head 41 so that the first head 41 performs a white ink ejection operation to eject the white ink onto the sheet S. The sheet S then is transported by the transporting belt 22 while being attracted by the transporting belt 22. The sheet S is then positioned so that the first preliminary curing unit 51 faces the sheet S. Next, the controller 10 controls the first preliminary curing unit 51 so that the first preliminary curing unit 51 performs a white ink irradiation operation (preliminary curing process) to irradiate the white ink (ejected onto the sheet S by the first head 41) with the ultraviolet light (and to preliminarily cure the white ink). The sheet S is then transported by the transporting belt 22 while being attracted by the transporting belt 22. The sheet S is then positioned so that the second head 42 faces the sheet S.

After that, the controller 10 sequentially controls the second head 42, the second preliminary curing unit 52, the third head 43, the third preliminary curing unit 53, the fourth unit 34, the fourth head 44, and the fourth preliminary curing unit 54 so that the second head 42, the second preliminary curing unit 52, the third head 43, the third preliminary curing unit 53, the fourth unit 34, the fourth head 44, and the fourth preliminary curing unit 54 perform a cyan ink ejection operation, a cyan ink irradiation operation (preliminary curing process to preliminarily cure the cyan ink), yellow ink ejection operation, a yellow ink irradiation operation (preliminary curing process to preliminarily cure the yellow ink), a magenta ink ejection operation, and a magenta ink irradiation operation (preliminary curing process to preliminarily cure the magenta ink), respectively.

After the preliminary curing processes, the controller 10 controls the main curing unit 60 so that the main curing unit 60 performs the main curing process to irradiate the white, cyan, magenta and yellow ink (deposited on the sheet S) with the ultraviolet light and cure the white, cyan, magenta and yellow ink. After the main curing process, the sheet S is delivered out of the printer 1.

In the main curing process, the main curing unit 60 irradiates each ink with electromagnetic wave that includes high-intensity of ultraviolet light and cures each ink. Since the sheet S is also irradiated with the electromagnetic wave, the sheet S is subjected to heat and subsequently tries to deform (e.g., tries to bend). However, the transporting belt 22 suppresses the deformation since the sheet S is attracted electrostatically or by vacuum using the transporting belt 22.

### Effectiveness of Printer 1

According to the present embodiment, the distance between the fourth preliminary curing unit 54 and the main curing unit 60 in the transporting direction is smaller than the length of the sheet S in the transporting direction, and the transporting belt 22 attracts the sheet S. Thus, the compact printing device can be provided while suppressing a reduction in the quality of an image.

If the fourth preliminary curing unit 54 and the main curing unit 60 were located so that the distance L₅ was larger than the length L_{S} of the sheet S in the transporting direction in order to prevent the sheet S from being deformed (e.g., being bent) due to the electromagnetic wave with which the main curing unit 60 irradiates the sheet S, the printing device would be large. In this case, a user needs a large space to accommodate the printing device. In the present embodiment, however, the transporting belt 22 attracts the sheet S and the main curing unit 60 irradiates the sheet S with the ultraviolet light. Thus, the printing device can suppress the deformation (such as bending) of the sheet S and can therefore prevent the magenta ink from being formed into an inappropriate shape before the completion of the preliminary curing process. Therefore, the compact printing device can be provided while preventing a reduction in the quality of the image.

In addition, according to the present embodiment, the main curing unit 60 is arranged so that the distance (L₄ₐ+L_{L4}+L₅) between the fourth head 44 and the main curing unit 60 is larger than the length L_{S} of the sheet S in the transporting direction. Thus, the main curing process is performed by the main curing unit 60 to cure the ultraviolet curable ink on the sheet S after the completion of the operation for ejecting the ultraviolet curable ink from the fourth head 44. Therefore, the operation for ejecting the ultraviolet curable ink is not adversely affected by the deformation (caused by the main curing process) of the sheet S, and a reduction in the quality of the image can be prevented. If the sheet S were slightly deformed at the time of the operation for ejecting the ink from the fourth head 44, the ink would not form into an appropriate shape on the sheet S. In the present embodiment, however, the main curing unit 60 irradiates the sheet S with the ultraviolet light after the completion of the operation for ejecting the ink from the fourth head 44. Thus, the ink is not formed into an inappropriate shape. Therefore, the compact printing device can be provided while preventing a reduction in the quality of the image.

### Other Embodiments

The embodiment mainly describes the printing device but includes a printing method. In addition, the embodiment is provided to easily understand the invention and should not be interpreted to limit the invention. The aforementioned embodiment may be changed and modified without departing from the gist of the invention, and the invention includes equivalents of the embodiment.

Embodiments described below are included in the invention.

### Printing Device

In the aforementioned embodiment, the ink jet printer is used as the printing device. However, the invention can be applied to other printing devices.

### Moving Mechanism

In the aforementioned embodiment, the transporting unit 20 transports the sheet S so that the sheet S moves relative to the heads 40. However, the moving mechanism is not limited to the transporting unit 20. For example, the heads 40, the preliminary curing units 50 and the main curing unit 60 may move while the sheet S may be located at a predetermined position so that the heads 40 move relative to the sheet S.

### Heads

In the aforementioned embodiment, the heads 40 that use the piezoelectric elements to eject the ink are used. However, a method for ejecting the liquids is not limited to the aforementioned method. For example, another method such as a method for generating bubble in the nozzles with heat may be used.

### Ultraviolet Curable Ink, Preliminary Curing Units and Main Curing Unit

In the aforementioned embodiment, the ultraviolet curable ink is used as the ink that has been ejected from the heads 40, and the ultraviolet light is used as the electromagnetic waves with which the preliminary curing units 50 and the main curing unit 60 irradiate the ink. The invention is not limited to the ultraviolet curable ink and the ultraviolet light. For example, the preliminary curing units 50 and the main curing unit 60 may irradiate the ink with electromagnetic waves such as electron rays, X rays, visible rays or infrared rays, and the ink may be ink that can be cured by the electromagnetic waves.

### Arrangement of Main Curing Unit

In the aforementioned embodiment, the A4-sized and B4-sized sheets are stored in the storage unit 25. The invention is not limited to the A4-sized and B4-sized sheets. For example, A3-sized and B5-sized sheets may be stored in the storage unit 25. In addition, when the sheet S is fed from the storage unit 25 onto the transporting belt 22, the longitudinal direction of the sheet S does not need to match the transporting direction. The sheet S may be fed from the storage unit 25 onto the transporting belt 22 so that the longitudinal direction of the sheet S matches a direction that intersects the transporting direction.

In the aforementioned embodiment, the position of the fourth head 44, the position of the fourth preliminary curing unit 54 and the position of the main curing unit 60 are fixed. However, the invention is not limited to this. For example, the fourth head 44, the fourth preliminary curing unit 54 and the main curing unit 60 may be movable. The fourth head 44, the fourth preliminary curing unit 54 and the main curing unit 60 may be moved on the basis of the length L_{S} of a selected sheet S.

Specifically, when the controller 10 receives, from the computer 80, the print data, data on the size of the sheet S and data on a direction in which the sheet S is to be printed, the controller 10 may move the fourth preliminary curing unit 54 and the main curing unit 60 on the basis of the size of the sheet S so that the distance L₅ between the fourth preliminary curing unit 54 and the main curing unit 60 is smaller than the length L_{S} of the sheet S in the transporting direction and the distance (L₄ₐ+L_{L4}+L₅) between the fourth head 44 and the main curing unit 60 is larger than the length L_{S} of the sheet S in the transporting direction.

What is claimed is:

1. A printing device comprising:
a storage unit that stores a medium having a predetermined size;
an attracting unit that attracts the medium;
heads that eject radiation curable ink onto the medium;
a moving mechanism that moves the medium relative to the heads in a moving direction;
preliminary curing units that are respectively located on downstream sides of the heads in the moving direction and irradiate the radiation curable ink deposited on the medium with electromagnetic waves to preliminarily cure the radiation curable ink; and
a main curing unit that is located on a downstream side of the preliminary curing unit located on the most downstream side among the preliminary curing units in the moving direction so that a distance between the main curing unit and the preliminary curing unit located on the most downstream side in the moving direction is smaller than the length of the medium in the moving direction and that irradiates the radiation curable ink deposited on the medium with an electromagnetic wave to cure the radiation curable ink.

2. The printing device according to claim 1, wherein
the main curing unit is located so that a distance between the main curing unit and the head located on the most downstream side among the heads in the moving direction is larger than the length of the medium in the moving direction.

3. The printing device according to claim 1, wherein
the main curing unit uses an electromagnetic lamp to irradiate the radiation curable ink with the electromagnetic wave, and
the preliminary curing units use light emitting diodes to irradiate the radiation curable ink with the electromagnetic waves.

4. A printing method comprising:
supplying a medium having a predetermined size from a storage unit that stores the medium;
causing an attracting unit to attract the medium;
causing a moving mechanism to move the medium relative to heads in a moving direction while the medium is attracted by the attracting unit;
causing the heads to eject radiation curable ink onto the medium that is attracted by the attracting unit;
causing preliminary curing units to irradiate the radiation curable ink with electromagnetic waves to preliminarily cure the radiation curable ink deposited on the medium, the preliminary curing units being respectively located on downstream sides of the heads in the moving direction; and
causing a main curing unit to irradiate the radiation curable ink deposited on the medium with an electromagnetic wave and cure the radiation curable ink, the main curing unit being located on a downstream side of the preliminary curing unit located on the most downstream side among the preliminary curing units in the moving direction so that a distance between the main curing unit and the preliminary curing unit located on the most downstream side in the moving direction is smaller than the length of the medium in the moving direction.
